(19) United States
(12) Patent Application Publication
(10) Pub. No.: US 2008/0311441 A1
(43) Pub. Date: Dec. 18, 2008

(54) FUEL CELL SYSTEM USING CATHODE EXHAUST FOR ANODE RECIRCULATION

(76) Inventors: Clark G. Hochgraf, Honeoye Falls, NY (US); Jon R. Sienkowski, Rochester, NY (US); John P. Salvador, Penfield, NY (US)

Correspondence Address: FRASER CLEMENS MARTIN & MILLER LLC, 28366 KENSINGTON LANE, PERRYSBURG, OH, 43551-4163, US

(21) Appl. No.: 11/762,875

(22) Filed: Jun. 14, 2007

(51) Int. Cl. H01M 8/04; H01M 8/18

(52) U.S. Cl. 429/17; 429/19

(57) ABSTRACT

A system for providing fuel recirculation in a fuel cell is disclosed, wherein the system uses a cathode exhaust flow to energize a fuel recirculation pump that facilitates the fuel recirculation from an anode exhaust passage to an anode supply passage.

### FIELD OF THE INVENTION

The present invention relates to fuel cells and more particularly to a fuel cell system that uses a cathode exhaust flow to energize a pump that facilitates anode recirculation.

### BACKGROUND OF THE INVENTION

A hydrogen fuel cell is an electrochemical device that includes an anode and a cathode with an electrolyte disposed therebetween. The anode receives a fuel such as hydrogen gas and the cathode receives an oxidant such as oxygen or air. Typically, a main hydrogen inlet passage provides fluid communication between a source of hydrogen and the anode. Several fuel cells may be combined in a fuel cell stack to generate a desired amount of electrical power. A fuel cell stack for a vehicle may include several hundred individual cells.

Oxygen not consumed in the fuel cell stack is expelled as a cathode exhaust gas that may include water as a stack by-product. Hydrogen not consumed in the stack may be recirculated to the main hydrogen passage via a fuel recirculation passage. An undesirable amount of nitrogen is often present in the unused hydrogen exiting the fuel cell. Before reintroducing the unused hydrogen back into the main hydrogen inlet passage, a portion of the hydrogen/nitrogen mixture is exhausted into the atmosphere. The exhausting can be accomplished by a bleed valve, for example. Hydrogen and nitrogen that is not exhausted into the atmosphere through the bleed valve can be reintroduced to the main hydrogen supply via the fuel recirculation passage. The fuel recirculation passage provides fluid communication between the outlet of the fuel cell and the main hydrogen inlet passage to allow unused hydrogen to be reintroduced to the anode. Typically, an electric pump is used to recirculate the hydrogen/nitrogen mixture back into the main hydrogen inlet passage.

It has been a continuing challenge to provide an efficient and cost effective method of reintroducing the unused hydrogen back into the main hydrogen inlet passage. Space in and around the fuel cell stack is extremely limited and valued, especially in vehicular applications. Further, the electric pump used to reintroduce the unused hydrogen back into the main hydrogen passage utilizes electrical power generated by the fuel cell stack, thereby decreasing overall efficiency.

It would be desirable to produce a fuel cell system that supports hydrogen recirculation, wherein a cost and a weight of the system are minimized and a fuel efficiency of the system is maximized.

### SUMMARY OF THE INVENTION

Harmonious with the present invention, a fuel cell system that supports hydrogen recirculation, wherein a cost and a weight of the system are minimized and a fuel efficiency of the system is maximized, has surprisingly been discovered.

In one embodiment, a fuel cell system comprises: a fuel cell stack having an cathode supply passage in fluid communication with an oxidant source and an anode supply passage in fluid communication with a fuel source, the fuel cell stack including an anode exhaust passage and a cathode exhaust passage; a fuel recirculation pump in fluid communication with the anode exhaust passage and the anode supply passage; and an energy imparting device in fluid communication with the cathode exhaust passage and adapted to be driven by a pressure therein, the energy imparting device adapted to cause an operation of the fuel recirculation pump to recirculate at least a portion of an anode exhaust from the anode exhaust passage to the anode supply passage.

In another embodiment, a fuel cell system comprises: an oxidant source in fluid communication with a cathode supply passage; a fuel source in fluid communication with an anode supply passage; a fuel cell stack in fluid communication with the cathode supply passage and the anode supply passage, the fuel cell stack including an anode exhaust passage and a cathode exhaust passage; a fuel recirculation pump in fluid communication with the anode exhaust passage; an energy imparting device in fluid communication with the cathode exhaust passage and adapted to be driven by a pressure therein, the energy imparting device adapted to cause an operation of the fuel recirculation pump to recirculate at least a portion of an anode exhaust from the anode exhaust passage to the anode supply passage; and a back pressure valve in fluid communication with the cathode exhaust passage and disposed downstream from the energy imparting device, wherein the back pressure valve is positionable in at least one of an open, a closed, and an intermediate position to selectively permit a flow of fluid therethrough.

A method for recirculating fuel in a fuel cell system is disclosed, the method comprising the steps of: providing a fuel cell stack having an anode supply passage in fluid communication with a fuel source, an anode exhaust passage, a cathode supply passage in fluid communication with an oxidant source, and a cathode exhaust passage; providing a fuel recirculation pump in fluid communication with the anode exhaust passage; providing an energy imparting device in fluid communication with the cathode exhaust passage and adapted to be driven by a pressure therein; causing the energy imparting device to drive the fuel recirculation pump; and recirculating at least a portion of an anode exhaust from the anode exhaust passage to the anode supply passage.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is an exploded perspective view of a fuel cell system according to the prior art;

FIG. 2 is a schematic flow diagram of a fuel cell system in accordance with an embodiment of the invention; and

FIG. 3 is a schematic flow diagram of a fuel cell system in accordance with another embodiment of the invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed and illustrated, the steps presented are exemplary in nature, and thus, the order of the steps is not necessary or critical.

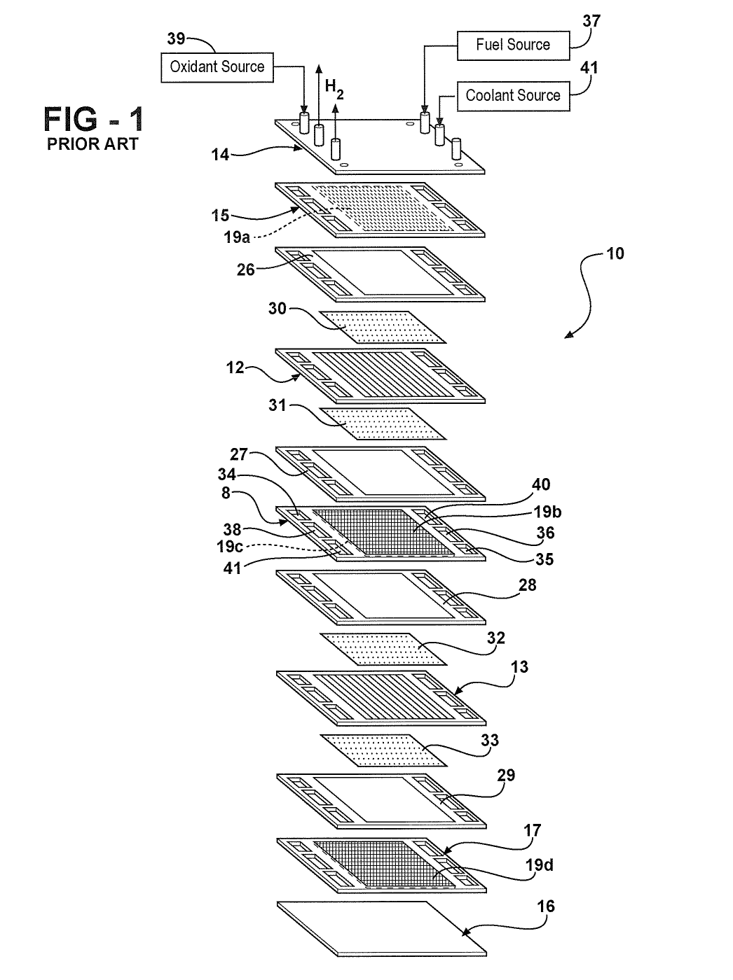

FIG. 1 depicts an illustrative two-cell, bipolar PEM fuel cell stack 10 having a pair of membrane electrode assemblies (MEAs) 12, 13 separated from each other by an electrically conductive bipolar plate 8. The MEAs 12, 13 and bipolar plate 8 are stacked together between a pair of clamping plates 14, 16, and a pair of unipolar end plates 15, 17. The clamping plates 14, 16 are electrically insulated from the unipolar end plates 15, 17 by a gasket or a dielectric coating (not shown). The unipolar end plates 15, 17, as well as both working faces of the bipolar plate 8, include a plurality of grooves or channels 19a, 19b, 19c, 19d defining a flow field for distributing a fuel, such as hydrogen, and an oxidant such as air, over the faces of the MEAs 12, 13. Nonconductive gaskets 26, 27, 28, 29 provide seals and an electrical insulation between the several components of the fuel cell stack. Gas-permeable diffusion media 30, 31, 32, 33, e.g. carbon or graphite diffusion papers, abut an anode face and a cathode face of the MEAs 12, 13. The unipolar end plates 15, 17 are disposed adjacent to the diffusion media 30, 33 respectively, while the bipolar plate 8 is disposed adjacent to the diffusion media 31 on the anode face of MEA 12. The bipolar plate 8 is further disposed adjacent to the diffusion media 32 on the cathode face of MEA 13.

The fuel cell stack 10 is in fluid communication with a fuel source 37 an oxidant source 39, and a coolant source 41. The fuel cell stack 10 further includes a cathode supply passage 34 in fluid communication with the oxidant source 39, a cathode exhaust passage 35, a coolant supply passage 36 in fluid communication with the coolant source 41, a coolant exhaust passage 38, an anode supply passage 40 in fluid communication with the fuel source 37, and an anode exhaust passage 42. The supply passages 34, 36, 40 and the exhaust passages 35, 38, 42 are formed, for example, by a cooperation of conduits disposed between the sources 37, 39, 41 and the fuel cell stack 10 with apertures formed in the bipolar plate 8, apertures formed in the gaskets 26, 27, 28, 29, and apertures formed in the unipolar end plates 15, 17.

A typical fuel cell stack (not shown) is constructed of a plurality of fuel cell stacks 10 connected in series. Such a typical fuel cell stack is commonly used as a power plant for the generation of electric power in a vehicle, for example.

In use, a fuel such as hydrogen, for example, is supplied from the fuel source 37, an oxidant such as oxygen, for example, is supplied from the oxidant source 39, and a coolant is supplied from the coolant source 41. The fuel, oxidant, and coolant from respective sources 37, 39, 41 diffuse through the supply passages 34, 36, 40 to opposing sides of the MEAs 12, 13. Porous electrodes (not shown) form an anode (not shown) and a cathode (not shown), and are separated by a Proton Exchange Membrane (not shown). The PEM provides for ion transport to facilitate a chemical reaction in the fuel cell stack 10. Typically, the PEM is produced from copolymers of suitable monomers. Such proton exchange membranes may be characterized by monomers of the structures:

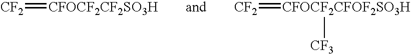

Such a monomer structure is disclosed in U.S. Pat. No. 5,316,871 to Swarthirajan et al., hereby incorporated herein by reference in its entirety.

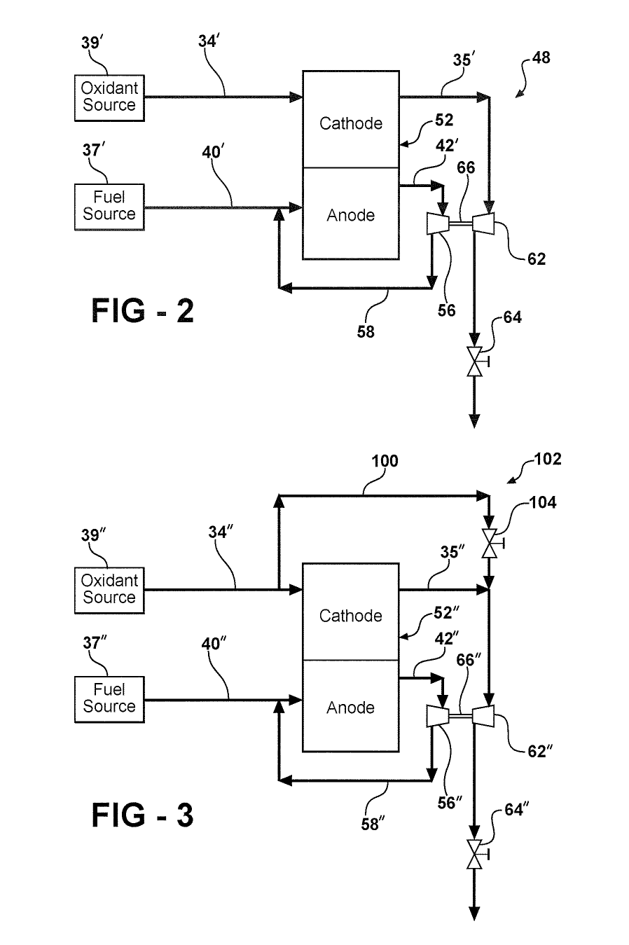

FIG. 2 shows a flow diagram of a fuel cell system 48 in accordance with an embodiment of the invention, wherein similar structure to that described above for FIG. 1 includes the same reference numeral followed by a prime (′) symbol. The fuel cell system 48 includes a fuel source 37′, an oxidant source 39′, a fuel cell stack 52 including one or more fuel cells stacks 10 as described above for FIG. 1, a fuel recirculation pump 56, an energy imparting device 62 such as a turbocharger, for example, and a back pressure valve 64.

The fuel source 37′ and the fuel cell stack 52 are in fluid communication by means of an anode supply passage 40′. The oxidant source 39′ and the fuel cell stack 52 are in fluid communication by means of a cathode supply passage 34′. The fuel cell stack 52, an anode exhaust passage 42′, and the fuel recirculation pump 56 are in fluid communication with a fuel recirculation passage 58. The fuel cell stack 52, the energy imparting device 62, and the back pressure valve 64 are in fluid communication by means of a cathode exhaust passage 35′. The fuel recirculation pump 56 and the energy imparting device 62 are mechanically coupled by a shaft 66 disposed therebetween. It is understood that the fuel recirculation pump 56, the shaft 66, and the energy imparting device 62 can be formed separately or integrally as desired. It is also understood that the fuel recirculation pump 56 may be coupled directly to the energy imparting device 62 without the shaft 66. The back pressure valve 64 as shown is a butterfly type multi-position valve. It is understood that other types of valves can be used as desired. It is also possible that the back pressure valve 64 can be removed from the fuel cell system 48 as desired.

In use, the fuel source 37′ provides a fuel such as hydrogen, for example, to the fuel cell stack 52 by means of the anode supply passage 40′ and the oxidant source 39′ provides an oxidant such as oxygen, for example to the fuel cell stack 52 by means of the cathode supply passage 34′. Once in the fuel cell stack 52, a reaction between the oxidant and the fuel results in the creation of electrical energy as is known in the art. Fuel not consumed by the reaction is discharged through the anode exhaust passage 42′.

Typically, an amount of nitrogen is present in the fuel cell system 48. The nitrogen and oxidant not consumed by the reaction, along with water produced by the reaction (hereinafter collectively referred to as cathode exhaust) are discharged through the cathode exhaust passage 35′. The pressure within the cathode exhaust passage 35′ is regulated by the back pressure valve 64, and can be 20 kPa or more, for example, although other pressures can be used as desired. A controller (not shown) including a pressure sensor (not shown) is used to measure the pressure within the cathode exhaust passage 35′. The controller transmits a signal to cause an opening and a closing of the back pressure valve 64 as a higher or a lower pressure within the cathode exhaust passage 35′ is desired.

The pressure in the cathode exhaust passage 35′ provides energy for operation of the energy imparting device 62. The energy is transferred to the fuel recirculation pump 56 by rotation of the shaft 66. The fuel recirculation pump 56 recirculates fuel flowing in the anode exhaust passage 42′ to the anode supply passage 40′ through the fuel recirculation passage 58. Typically, a bleed valve (not shown) is disposed in the fuel recirculation passage 58 to facilitate a discharge of a portion of the cathode exhaust to escape from the fuel cell system 48. The back pressure valve 64 can be adjusted by the controller to control the amount of pressure in the cathode exhaust passage 35′, thus controlling the amount of energy transferred from the energy imparting device 62 to the fuel recirculation pump 56. To simplify the fuel cell system 48, the amount of pressure in the cathode exhaust passage 35′ may be uncontrolled, wherein the amount of energy transferred from the energy imparting device 62 to the fuel recirculation pump 56 would also be uncontrolled.

The fuel cell system 48 facilitates fuel recirculation for the fuel cell system 48 while minimizing a weight and a cost thereof. Thus, an efficiency of the fuel cell system 48 is maximized.

The amount of energy that is available from the pressure within the cathode exhaust passage 35′ is typically sufficient to produce a desired amount of fuel recirculation. However, under certain conditions, the available energy is less than that required for the desired amount of fuel recirculation. However, additional pressure can be provided to drive the fuel recirculation pump 56 either directly from the fuel cell stack 52 or through a cathode stack bypass passage 100. Such a cathode stack bypass passage 100 is shown in FIG. 3, wherein similar structure to that described above for FIGS. 1 and 2 includes the same reference numeral followed by a double prime (″) symbol.

The fuel cell system 102 shown in FIG. 3 includes a fuel source 37″, an oxidant source 39″, a fuel cell stack 52″ including one or more fuel cell stacks 10 as described above for FIG. 1, a fuel recirculation pump 56″, a bypass valve 104, an energy imparting device 62″ such as a turbocharger, for example, and a back pressure valve 64″.

The fuel source 37″ and the fuel cell stack 52″ are in fluid communication by means of an anode supply passage 40″. The oxidant source 39″ and the fuel cell stack 52″ are in fluid communication by means of a cathode supply passage 34″. The fuel cell stack 52″, an anode exhaust passage 42′″, and the fuel recirculation pump 56″ are in fluid communication with a fuel recirculation passage 58″. The oxidant source 39″, the cathode supply passage 34″, the bypass valve 104, and a cathode exhaust passage 35′″ are in fluid communication by means of the cathode stack bypass passage 100. The fuel cell stack 52″, the energy imparting device 62″, and the back pressure valve 64″ are in fluid communication by means of the cathode exhaust passage 35′″. The fuel recirculation pump 56″ and the energy imparting device 62″ are mechanically coupled by a shaft 66″ disposed therebetween. It is understood that the fuel recirculation pump 56″, the shaft 66″, and the energy imparting device 62″ can be formed separately or integrally as desired. It is also understood that the fuel recirculation pump 56″ may be coupled directly to the energy imparting device 62″ without the shaft 66″. The back pressure valve 64″ as shown is a butterfly type multi-position valve. It is understood that other types of valves can be used as desired. It is also possible that the back pressure valve 64″ can be removed from the fuel cell system 102 as desired.

In use, the fuel source 37″ provides a fuel such as hydrogen, for example, to fuel cell stack 52″ by means of the anode supply passage 40″ and the oxidant source 39″ provides an oxidant such as oxygen, for example to the fuel cell stack 52″ by means of the cathode supply passage 34″. Once in the fuel cell stack 52″, a reaction between the oxidant and the fuel results in the creation of electrical energy. Fuel not consumed by the reaction is discharged through the anode exhaust passage 42″.

Cathode exhaust is discharged from the fuel cell stack 52″ through the cathode exhaust passage 35″. The pressure within the cathode exhaust passage 35″ is regulated by the back pressure valve 64″ and the bypass valve 104. A controller (not shown) including a pressure sensor (not shown) is used to measure the pressure within the cathode exhaust passage 35″. The controller transmits a signal to cause an opening and a closing of the back pressure valve 64″ and/or the bypass valve 104 as a higher or lower pressure within the cathode exhaust passage 35″ is desired.

The pressure within the cathode exhaust passage 35″ provides energy for operation of the energy imparting device 62″. The fuel recirculation pump 56″ recirculates fuel in the anode exhaust passage 42″ to the anode supply passage 40″ through the fuel recirculation passage 58″. Typically, a bleed valve (not shown) is disposed in the fuel recirculation passage 58″ to facilitate a discharge of a portion of the cathode exhaust to escape from the fuel cell system 102.

If additional fuel recirculation is desired, the pressure in the cathode exhaust passage 35″ can be adjusted by varying the amount of oxidant permitted to flow through cathode stack bypass passage 100 and the bypass valve 104 into the cathode exhaust passage 35″. The pressure in the exhaust passage 35″ can also be varied by adjusting a position of the back pressure valve 64″ as discussed above for FIG. 2. Additionally, the pressure in the cathode exhaust passage 35″ can be controlled by varying the amount of oxidant permitted to flow through the cathode stack bypass passage 100 and the bypass valve 104 in combination with adjusting the position of the back pressure valve 64″. By controlling the pressure within the cathode exhaust passage 35″, the amount of the fuel recirculation facilitated by the fuel cell system 102 can be controlled.

The fuel cell system 102 facilitates fuel recirculation for the fuel cell system 102 while minimizing a weight and a cost thereof. Thus, an efficiency of the fuel cell system 102 is maximized. Additionally, the fuel cell system 102 facilitates a maximization of fuel recirculation when the pressure of the cathode exhaust alone is insufficient to drive the fuel recirculation pump 56″.

The fuel cell systems 48, 102 described above can be used with any fuel cell systems that include a cathode exhaust, a pressurized fluid capable of driving the energy imparting device 62, 62″, or a fuel recirculation function. These systems include, but are not limited to, hybrid recirculation systems, and cascading systems.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A fuel cell system comprising:
a fuel cell stack having an cathode supply passage in fluid communication with an oxidant source and an anode supply passage in fluid communication with a fuel source, the fuel cell stack including an anode exhaust passage and a cathode exhaust passage;
a fuel recirculation pump in fluid communication with the anode exhaust passage and the anode supply passage; and
an energy imparting device in fluid communication with the cathode exhaust passage and adapted to be driven by a pressure therein, the energy imparting device adapted to cause an operation of the fuel recirculation pump to recirculate at least a portion of an anode exhaust from the anode exhaust passage to the anode supply passage.

2. The fuel cell system according to claim 1 further comprising a back pressure valve in fluid communication with the cathode exhaust passage, wherein the back pressure valve is positionable in at least one of an open, a closed, and an intermediate position to selectively permit a flow of fluid therethrough.

3. The fuel cell system according to claim 2, wherein the back pressure valve is disposed downstream of the energy imparting device.

4. The fuel cell system according to claim 1, wherein the energy imparting device is a turbocharger.

5. The fuel cell system according to claim 4, wherein a shaft operably couples the turbocharger with the fuel recirculation pump.

6. The fuel cell system according to claim 1, further comprising a cathode stack bypass passage providing fluid communication between the cathode supply passage and the cathode exhaust passage.

7. The fuel cell system according to claim 6, further comprising a bypass valve disposed in the cathode stack bypass passage, wherein the bypass valve is positionable in at least one of an open, a closed, and an intermediate position to selectively permit a flow of fluid therethrough.

8. The fuel cell system according to claim 1, wherein the fuel recirculation pump is formed integrally with the energy imparting device.

9. A fuel cell system comprising:
an oxidant source in fluid communication with a cathode supply passage;
a fuel source in fluid communication with an anode supply passage;
a fuel cell stack in fluid communication with the cathode supply passage and the anode supply passage, the fuel cell stack including an anode exhaust passage and a cathode exhaust passage;
a fuel recirculation pump in fluid communication with the anode exhaust passage;
an energy imparting device in fluid communication with the cathode exhaust passage and adapted to be driven by a pressure therein, the energy imparting device adapted to cause an operation of the fuel recirculation pump to recirculate at least a portion of an anode exhaust from the anode exhaust passage to the anode supply passage; and
a back pressure valve in fluid communication with the cathode exhaust passage and disposed downstream from the energy imparting device, wherein the back pressure valve is positionable in at least one of an open, a closed, and an intermediate position to selectively permit a flow of fluid therethrough.

10. The fuel cell system according to claim 9, wherein the energy imparting device is a turbocharger.

11. The fuel cell system according to claim 10, wherein a shaft operably couples the turbocharger and the fuel recirculation pump.

12. The fuel cell system according to claim 9, further comprising a cathode stack bypass passage providing fluid communication between the cathode supply passage and the cathode exhaust passage.

13. The fuel cell system according to claim 12, further comprising a bypass valve disposed in the cathode stack bypass passage, wherein the bypass valve is positionable in at least one of an open, a closed, and an intermediate position to selectively permit a flow of fluid therethrough.

14. The fuel cell system according to claim 9, wherein the fuel recirculation pump is formed integrally with the energy imparting device.

15. A method for recirculating fuel in a fuel cell system comprising the steps of:
providing a fuel cell stack having an anode supply passage in fluid communication with a fuel source, an anode exhaust passage, a cathode supply passage in fluid communication with an oxidant source, and a cathode exhaust passage;
providing a fuel recirculation pump in fluid communication with the anode exhaust passage;
providing an energy imparting device in fluid communication with the cathode exhaust passage and adapted to be driven by a pressure therein;
causing the energy imparting device to drive the fuel recirculation pump; and
recirculating at least a portion of an anode exhaust from the anode exhaust passage to the anode supply passage.

16. The method for recirculating fuel according to claim 15, further comprising the step of providing a back pressure valve in fluid communication with the cathode exhaust passage, wherein the back pressure valve is positionable in at least one of an open, a closed, and an intermediate position to selectively permit a flow of fluid therethrough.

17. The method for recirculating fuel according to claim 16, wherein the back pressure valve is disposed in the cathode exhaust passage downstream of the energy imparting device.

18. The method for recirculating fuel according to claim 15, further comprising the step of providing a cathode stack bypass passage providing fluid communication between the cathode supply passage and the cathode exhaust passage.

19. The method for recirculating fuel according to claim 17, further comprising the step of providing a bypass valve in fluid communication with the cathode stack bypass passage, wherein the bypass valve is positionable in at least one of an open, a closed, and an intermediate position to selectively permit a flow of fluid therethrough.

20. The method for recirculating fuel according to claim 15, wherein the energy imparting device is a turbo charger.
